(19) United States
(12) Patent Application Publication
(10) Pub. No.: US 2008/0076843 A1
(43) Pub. Date: Mar. 27, 2008

(54) Polyurethane foam composition possessing modified silicone surfactants

(75) Inventor: Roger Christopher Clark, Vienna, WV (US)

Correspondence Address: DILWORTH & BARRESE, LLP, 333 EARLE OVINGTON BLVD., SUITE 702, UNIONDALE, NY, 11553, US

(73) Assignee: General Electric Company, Schenectady, NY (US)

(21) Appl. No.: 11/524,808

(22) Filed: Sep. 21, 2006

(51) Int. Cl. C08L 75/00

(52) U.S. Cl. 521/137

(57) ABSTRACT

The invention relates to polyurethane form-forming composition possessing modified silicone surfactants and having delayed catalysis for modifying foam hardness and improved foam openness.

### FIELD OF INVENTION

This invention generally relates to a polyurethane foam-forming composition, and in particular to polyurethane form-forming composition possessing modified silicone surfactants and having delayed catalysis.

### BACKGROUND OF THE INVENTION

Polyurethane foams are produced by reacting a di- or polyisocyanate with compounds containing two or more active hydrogens, generally in the presence of catalysts, silicone-based surfactants and other auxiliary agents. The active hydrogen-containing compounds are typically polyols, primary and secondary polyamines, and water. Two major reactions are promoted by the catalysts among the reactants during the preparation of a polyurethane foam. These reactions must proceed simultaneously and at a competitively balanced rate during the process in order to yield a polyurethane foam with desired physical characteristics.

Reaction between the isocyanate and the polyol or polyamine, usually referred to as the gel reaction, leads to the formation of a polymer of high molecular weight. This reaction is predominant in foams blown exclusively with low boiling point organic compounds. The progress of this reaction increases the viscosity of the mixture and generally contributes to crosslink formation with polyfunctional polyols. The second major reaction occurs between isocyanate and water. This reaction adds to urethane polymer growth, and is important for producing carbon dioxide gas which promotes foaming. As a result, this reaction often is referred to as the blow reaction. The blow reaction is essential for avoiding or reducing the use of auxiliary blowing agents.

As noted above, in order to obtain a good urethane foam structure, the gel and blow reactions must proceed simultaneously and at optimum balanced rates. For example, if the carbon dioxide evolution is too rapid in comparison with the gel reaction, the foam tends to collapse. Alternatively, if the gel extension reaction is too rapid in comparison with the blow reaction generating carbon dioxide, foam rise will be restricted, resulting in a high-density foam. Also, poorly balanced crosslinking reactions will adversely impact foam stability. It is also important that there not be densification at the bottom of the foam.

Processes for preparing polyurethane foams, by reactions between a polyisocyanate and an active hydrogen-containing component conducted in the presence of a reaction product formed by reaction between a tertiary amnine and an aryloxy substituted carboxylic acid are disclosed in U.S. Pat. No. 6,660,781, and U.S. Pat. Nos. 6,395,796, 6,387,972 and 6,423,756 disclose processes for preparing polyurethane foams, by reactions between a polyisocyanate and an active hydrogen-containing component conducted in the presence of a reaction product formed by reaction between certain tertiary amnine, tertiary amnine carbamate(s) and hydroxy and/or an carboxylic acid having halo functionality. Polyurethane preparations prepared with acid blocked amine catalysts are disclosed in U.S. Pat. No. 6,525,107.

Some of the limitations of the aforementioned amines include delayed activity within the reaction until the salt is dissociated by the increasing temperature of the reacting mixture, their tightening effect on foam compositions, and inability to produce superior lower density grade TDI molded foam.

There remains a need in the polyurethane industry, therefore, for catalysts that allow formulators to modify the reactivity of polyurethane using silicone surfactants to complex with the amine catalyst to delay reactivity which can accommodate improved foam hardnesss, particularly for the low density grade TDI molded foams, and which can improve foam openness.

### SUMMARY OF THE INVENTION

The present invention is based on the discovery that silicone copolymers containing organic acids can complex with the amine catalyst(s), thus delaying the ability of the amine to promote the urethane (gel) and/or the urea (blow) reactions of a polyurethane foam-forming composition. Specifically, the present invention pertains to a polyurethane foam-forming composition comprising:
(a) at least one polyol;
(b) at least one polyisocyanate;
(c) at least one amine catalyst for the polyurethane-forming reaction;
(d) at least one silicone possessing carboxylic acid functionality; and,
(e) at least one blowing agent.

The silicone surfactants of the present invention can affect the reactivity of a polyurethane system to provide for better flow, openness and processing latitude in molded systems. In rigid polyurethane foams the silicone surfactants of the present invention provide for improved flow, cavity filling and thermal performance and/or dimensional stability.

### DESCRIPTION OF THE FIGURES

FIG. 1 is a graphical representation of the temperature profile of Comparative Example 1 and Examples 1 and 2.

FIG. 2 is a graphical representation of the rise profile of Comparative Example 1 and Examples 1 and 2.

FIG. 3 is a graphical representation of the rise profile of Comparative Example 3 and Example 6.

FIG. 4 is a graphical representation of the temperature profile of Comparative Example 3 and Example 6.

### DETAILED DESCRIPTION OF THE INVENTION

Polyols containing reactive hydrogen atoms generally employed in the production of polyurethane foams may be employed in the formulations of the present invention. The polyols are hydroxy-functional chemicals or polymers covering a wide range of compositions of varying molecular weights and hydroxy functionality. These polyhydroxyl compounds are generally mixtures of several components although pure polyhydroxyl compounds, i.e. individual compounds, may in principle be used.

The present invention is directed to polyurethane foam produced from polyurethane foam-forming composition comprising polyol (a) which is defined herein to be a normally liquid polymer possessing hydroxyl groups. Further, the polyol can be at least one of the type generally used to prepare polyurethane foams, e.g., a polyether polyol (a) having a molecular weight of from about 18 to about 10,000. The term “polyol” includes linear and branched polyethers (having ether linkages), polyesters and blends thereof, and comprising at least two hydroxyl groups.

Suitable polyols (a) include polyether polyol, polyester polyol, polyetherester polyols, polyesterether polyols, polybutadiene polyols, acrylic component-added polyols, acrylic component-dispersed polyols, styrene-added polyols, styrene-dispersed polyols, vinyl-added polyols, vinyl-dispersed polyols, urea-dispersed polyols, and polycarbonate polyols, polyoxypropylene polyether polyol, mixed poly (oxyethylene/oxypropylene)polyether polyol, polybutadienediols, polyoxyalkylene diols, polyoxyalkylene triols, polytetramethylene glycols, polycaprolactone diols and triols, and the like, all of which possess at least two primary hydroxyl groups. In one embodiment, some specific examples of polyether polyol (a) are polyoxyalkylene polyol, particularly linear and branched poly(oxyethylene)glycol, poly(oxypropylene)glycol, copolymers of the same and combinations thereof. Graft or modified polyether polyols, typically called polymer polyols, are those polyether polyols having at least one polymer of ethylenically unsaturated monomers dispersed therein. Non-limiting representative modified polyether polyols include polyoxypropylene polyether polyol into which is dispersed poly(styrene acrylonitrile) or polyurea, and poly(oxyethylene/oxypropylene)polyether polyols into which is dispersed poly(styrene acrylonitrile) or polyurea. Graft or modified polyether polyols comprise dispersed polymeric solids. Suitable polyesters of the present invention, include but are not limited to aromatic polyester polyols such as those made with pthallic anhydride (PA), dimethlyterapthalate (DMT) polyethyleneterapthalate (PET) and aliphatic polyesters, and the like. In one embodiment of the present invention, the polyether polyol (a) is selected from the group consisting of ARCOL® polyol U-1000, Hyperlite® E-848 from Bayer A G, Voranol® Dow BASF, Stepanpol® from Stepan, Terate® from Invista and combinations thereof.

Non-limiting examples of suitable polyols (a) are those derived from propylene oxide and ethylene oxide and an organic initiator or mixture of initiators of alkylene oxide polymerization and combinations thereof. As is well known, the hydroxyl number of a polyol is the number of milligrams of potassium hydroxide required for the complete hydrolysis of the fully acylated derivative prepared from one gram of polyol. The hydroxyl number is also defined by the following equation, which reflects its relationship with the functionality and molecular weight of polyether polyol (a):

$$OH No . = \frac{56.1 \times 1000 \times f}{M . W .}$$

wherein OH=hydroxyl number of polyether polyol (a); f=average functionality, that is, average number of hydroxyl groups per molecule of polyether polyol (a); and M.W.=number average molecular weight of polyether polyol (a). The average number of hydroxyl groups in polyether polyol (a) is achieved by control of the functionality of the initiator or mixture of initiators used in producing polyether polyol (a).

According to one embodiment of the present invention, polyol (a) can have a functionality of from about 2 to about 12, and in another embodiment of the present invention the polyol has a functionality of at least 2. It will be understood by a person skilled in the art that these ranges include all subranges there between.

In one embodiment of the present invention, polyurethane foam-forming composition comprises polyether polyol (a) having a hydoxyl number of from about 10 to about 4000. In another embodiment of the present invention, polyether polyol (a) has a hydroxyl number of from about 20 to about 2,000. In yet another embodiment polyether polyol (a) has a hydoxyl number of from about 30 to about 1,000. In still another embodiment polyether polyol (a) has a hydroxyl number of from about 35 to about 800.

Polyisocyanate (b) of the present invention, include any diisocyanate that is commercially or conventionally used for production of polyurethane foam. In one embodiment of the present invention, the polyisocyanate (b) can be organic compound that comprises at least two isocyanate groups and generally will be any of the known aromatic or aliphatic diisocyanates.

The polyisocyanates that are useful in the polyurethane foam-forming composition of this invention are organic polyisocyanate compounds that contain at least two isocyanate groups and generally will be any of the known aromatic or aliphatic polyisocyanates. According to one embodiment of the present invention, the polyisocyanate (b) can be a hydrocarbon diisocyanate, (e.g. alkylenediisocyanate and arylene diisocyanate), such as toluene diisocyanate, diphenylmethane isocyanate, including polymeric versions, and combinations thereof In yet another embodiment of the invention, the polyisocyanate (b) can be isomers of the above, such as methylene diphenyl diisocyanate (MDI) and 2,4- and 2,6-toluene diisocyanate (TDI), as well as known triisocyanates and polymethylene poly(phenylene isocyanates) also known as polymeric or crude MDI and combinations thereof. Non-limiting examples of isomers of 2,4- and 2,6-toluene diisocyanate include Mondur® TDI,_Papi 27 MDI and combinations thereof. For more rigid polyurethane foams, isocyanates are used, e.g., diisocyanates of MDI type and specifically crude polymeric MDI.

In one embodiment of the invention, the polyisocyanate (b) can be at least one mixture of 2,4-toluene diisocyanate and 2,6-toluene diisocyanate wherein 2,4-toluene diisocyanate is present in an amount of from about 80 to about 85 weight percent of the mixture and wherein 2,6-toluene diisocyanate is present in an amount of from about 20 to about 15 weight percent of the mixture. It will be understood by a person skilled in the art that these ranges include all subranges there between.

The amount of polyisocyanate (b) included in polyurethane foam-forming composition relative to the amount of other materials in polyurethane foam-forming composition is described in terms of “Isocyanate Index.” “Isocyanate Index” means the actual amount of polyisocyanate (b) used divided by the theoretically required stoichiometric amount of polyisocyanate (b) required to react with all active hydrogen in polyurethane foam-forming composition multiplied by one hundred (100). In one embodiment of the present invention, the Isocyanate Index in the polyurethane foam-forming composition used in the process herein is of from about 60 to about 300, and in another embodiment, of from about 70 to about 200 and in yet another embodiment, of from about 80 to about 120. It will be understood by a person skilled in the art that these ranges include all subranges there between.

Catalyst (c) for the production of the polyurethane foam herein can be a single catalyst or mixture of catalysts such as those commonly used to catalyze the reactions of polyol and water with polyisocyanates to form polyurethane foam. It is common, but not required, to use both an organoamine and an organotin compound for this purpose. Other metal catalysts can be used in place of, or in addition to, organotin compound. Suitable non-limiting examples of polyurethane foam-forming catalysts include (i) tertiary amines such as bis(2,2′-dimethylamino)ethyl ether, trimethylamine, triethylenediamine, 1,8-Diazabicyclo[5.4.0]undec-7-ene, triethylamine, N-methylmorpholine, N,N-ethylmorpholine, N,N-dimethylbenzylamine, N,N-dimethylethanolamine, N,N,N′,N′-tetramethyl-1,3-butanediamine, pentamethyldipropylenetriamine, triethanolamine, triethylenediamine, 2-{[2-(2-dimethylaminoethoxy)ethyl]methylamino}ethanol, pyridine oxide, and the like; (ii) strong bases such as alkali and alkaline earth metal hydroxides, alkoxides, phenoxides, and the like; (iii) acidic metal salts of strong acids such as ferric chloride, stannous chloride, antimony trichloride, bismuth nitrate and chloride, and the like; (iv) chelates of various metals such as those which can be obtained from acetylacetone, benzoylacetone, trifluoroacetylacetone, ethyl acetoacetate, salicylaldehyde, cyclopentanone-2-carboxylate, acetylacetoneimine, bis-acetylaceone-alkylenediimines, salicylaldehydeimine, and the like, with various metals such as Be, Mg, Zn, Cd, Pb, Ti, Zr, Sn, As, Bi, Cr, Mo, Mn, Fe, Co, Ni, or such ions as MoO₂++, UO₂++, and the like; (v) alcoholates and phenolates of various metals such as Ti(OR)₄, Sn(OR)₄, Sn(OR)₂, Al(OR)₃, and the like, wherein R is alkyl or aryl of from 1 to about 12 carbon atoms, and reaction products of alcoholates with carboxylic acids, beta-diketones, and 2-(N,N-dialkylamino) alkanols, such as well known chelates of titanium obtained by this or equivalent procedures; (vi) salts of organic acids with a variety of metals such as alkali metals, alkaline earth metals, Al, Sn, Pb, Mn, Co, Bi, and Cu, including, for example, sodium acetate, potassium laurate, calcium hexanoate, stannous acetate, stannous octoate, stannous oleate, lead octoate, metallic driers such as manganese and cobalt naphthenate, and the like; (vii) organometallic derivatives of tetravalent tin, trivalent and pentavalent As, Sb, and Bi, and metal carbonyls of iron and cobalt; and combinations thereof. In one specific embodiment organotin compounds that are dialkyltin salts of carboxylic acids, can include the non-limiting examples of dibutyltin diacetate, dibutyltin dilaureate, dibutyltin maleate, dilauryltin diacetate, dioctyltin diacetate, dibutyltin-bis(4-methylaminobenzoate), dibuytyltindilaurylmercaptide, dibutyltin-bis(6-methylaminocaproate), and the like, and combinations thereof. Similarly, in another specific embodiment there may be used trialkyltin hydroxide, dialkyltin oxide, dialkyltin dialkoxide, or dialkyltin dichloride and combinations thereof. Non-limiting examples of these compounds include trimethyltin hydroxide, tributyltin hydroxide, trioctyltin hydroxide, dibutyltin oxide, dioctyltin oxide, dilauryltin oxide, dibutyltin-bis(isopropoxide) dibutyltin-bis(2-dimethylaminopentylate), dibutyltin dichloride, dioctyltin dichloride, and the like, and combinations thereof.

In one embodiment, catalyst (c) can be an organotin catalyst selected from the group consisting of stannous octoate, dibutyltin dilaurate, dibutyltin diacetate, stannous oleate and combinations thereof. In another embodiment, catalyst (c) can be an organoamine catalyst, for example, tertiary amine such as trimethylamine, triethylamine, triethylenediamine, bis(2,2′-dimethylamino)ethyl ether, N-ethylmorpholine, diethylenetriamine, 1,8-Diazabicyclo[5.4.0]undec-7-ene and combinations thereof. In another embodiment, catalyst (c) can include mixtures of tertiary amine and glycol, such as Niax® catalyst C-183 (GE), stannous octoate, such as Niax® catalyst D-19 (GE, and combinations thereof.

According to one embodiment of the present invention, the amine catalysts (c), for the production of flexible slabstock and molded foams, include bis(N,N-dimethylaminoethyl)ether and 1,4-diazabicyclo[2.2.2]octane. In another embodiment of the invention, for the production of rigid foams, the amine catalysts include dimethylcyclohexylamine (DMCHA) and dimethylethanolamine (DMEA) and the like.

In another embodiment amine catalysts can include mixtures of tertiary amine and glycol, such as Niax® catalyst C-183, stannous octoate, such as Niax® catalyst D-19 and combinations thereof, all available from GE Advanced Materials, Silicones.

The at least one silicone possessing carboxylic acid functionality (d) of the present invention possesses a polymeric backbone including repeating siloxy units that have alkyl, aryl, polyether, polyester pendant groups with at least one carboxylic acid (COOH) functionality. The amine catalyst-delaying silicone (d) of the present invention is particularly suitable as a surfactant in the polyurethane foam-forming compositions. The silicone (d) maintain its mobility in the initial stages of the polyurethane foam-forming composition reaction by complexing with the amine catalyst(s) to delay the rise and temperature of the polyurethane foam, stabilize the growth and size of cells within the foam and finally react into the polymer matrix by reacting with the isocyanate to remain in the polymer matrix. The silicone surfactants of the present invention can contain one or more acid groups and can be used in conjunction with other silicone surfactants to control the amount of delay. Silicone (d) can be used with any typical amine catalyst in polyurethane foams, and optionally, in combination with metal catalysts such as potassium and tin complexes.

Typically, silicone surfactants are prepared by reacting a polyhydridosiloxane of general formula M**D, D′_{y} M** with an appropriately chosen blend of allyl-started oxyalkylene polymers in the presence of a hydrosilation catalyst, e.g., chloroplatinic acid. In the general formula, M** is (CH₃)(H)SiO_{1/2} or (CH₃)₃ SiO_{1/2}, D is (CH₃)₂ SiO_{2/2}, and D′ represents (CH₃)(H)SiO_{2/2}. The allyl-started oxyalkylene polymers are polyethers having a terminal vinyl group, which may optionally be 2-substituted, and containing multiple units derived from ethylene oxide, propylene oxide, or both. The reagents are mixed, generally in a solvent such as toluene or dipropylene glycol, heated to about 70°-85° C., then the catalyst is added, a temperature rise of about 10-15° C. is observed, and the mixture is finally sampled and analyzed for SiH groups by adding an alcohol and base and measuring evolved hydrogen. If a volatile solvent was used, this is removed under vacuum, and the mixture is generally neutralized with a weak base such as NaHCO₃, then filtered.

The polyhydridosiloxanes of the general formula M**DₓD′_{y} M** are prepared in the manner known to the art. For the case in which M** is (CH₃)₃ SiO₁/2, an alkyldisiloxane such as hexamethyldisiloxane, a polyhydridosiloxane polymer, and an alkyl cyclosiloxane such as octamethylcyclotetrasiloxane are reacted in the presence of a strong acid such as sulfuric acid. For the case in which M** is (H)(CH₃)₂SiO₂/2, a hydridoalkyldisiloxane such as dihydridotetramethyldisiloxane, a polyhydridosiloxane polymer, and an alkyl cyclosiloxane such as octamethylcyclotetrasiloxane are reacted in the presence of a strong acid such as sulfuric acid.

The allyl-started oxyalkylene polymers, also referred to as polyethers, are likewise prepared in the manner known to the art. An allyl alcohol, optionally bearing a substituent on the 1 or 2-position, is combined with ethylene oxide, propylene oxide, or both, in the presence of an acid or a base, to yield the desired polyether with a terminal hydroxyl group. This is typically capped by further reaction with an alkylating or acylating agent such as a methyl halide or acetic anhydride, respectively. Other end caps may of course be employed.

Procedures for synthesizing nonhydrolyzable silicone surfactants having polyalkylene oxide pendant groups are well known. Representative disclosures are provided in U.S. Pat. Nos. 4,147,847 and 4,855,379, relevant portions of which are hereby incorporated by reference.

Carboxy-functional silicones and methods for preparing them are known in the art, for example, U.S. Pat. Nos. 3,182,076 and 3,629,165, (both to Holdstock) and RE 34,415. The entire contents of the foregoing U.S. patent documents are incorporated by reference herein. In the Holdstock method, carboxy-functional silicones are prepared by the hydrolysis and condensation of a mixture containing organotrichlorosilane, a diorganodichlorosilane, and a cyanoalkyldiorganochlorosilane. During the hydrolysis and condensation of these reactants, the various silicon-bonded chlorine atoms are replaced by silicon-bonded hydroxyl groups which intercondense to form siloxane linkages. The nitrile radical hydrolyzes to a carboxyl radical. Hydrochloric acid is also formed in the hydrolysis reaction.

Silicone (d) also can be obtained by reacting a mixture of ingredients containing an olefin-terminated organoacyloxysilane, an organohydrogenpolysiloxane, and a precious metal or a precious metal-containing catalyst and then hydrolyzing the reaction product formed in the first step to form the final product, i.e., the carboxy functional silicone.

Another synthetic route for the production of a carboxylic acid adduct consists of reacting an unsaturated acid such as 10-undecenoic acid with trimethylchlorosilane to form the silyl ester followed by a catalytic hydrosilation. A subsequent hydrolysis of the hydrosilated trimethylchlorosilylester of unsaturated acid will yield the siloxy carboxylic acid derivative, as taught in U.S. Pat. No. 4,990,643, which is herewith incorporated by reference.

A similar reaction pathway that could be utilized to provide carboxy functionalized silicones is that taught by Ryang in U.S. Pat. No. 4,381,396, herewith incorporated by reference, wherein a hydride fluid is reacted with a norbornene carboxylic acid anhydride in the presence of a platinum hydrosilation catalyst to yield silicon functionalized norbornane mono-anhydrides or di-anhydrides. Ryang teaches the use of such compounds for the synthesis of organosilicon polyimide copolymers and polydiorganosiloxane polyimide block polymers and copolymers. However, a simple hydrolytic reaction of the mono- or di-anhydride should yield a carboxylic acid functionalized norbornylsiloxane or silicone. The use of norbornyl compounds is complicated by their well-known high levels of toxicity.

Another method of preparing silicone containing carboxylic acids is summarized by the reaction of an unsaturated polyether with a siloxane containing silicon hydride to form a silicon carbinol or polyether silicone that can be subsequently reacted with an acid anhydride or acid halide to yield a carboxylic acid functionalized silicone or siloxane derivative. This process is described by Raleigh et al. in U.S. Pat. No. 5,447,997, incorporated by reference herein, and is generally characterized by the following reaction scheme: a) an organic acid anhydride or organic acid halide is reacted with, b) a hydroxy functionalized polyether silicone or siloxane to yield, c) a polyether silicone polymer or copolymer carboxylic acid; and optionally, d) neutralization comprising the use of an alkali metal, especially the salts of lithium, sodium, and potassium. Specifically in Raleigh, the hydroxy functionalized polyether silicone is prepared via a hydrosilation reaction with an unsaturated polyether.

The silicone surfactant must contain at least one pendant acid group that can be derived from various methods including direct hydrosilation of acid containing groups or the derivatization of acid groups through various reaction mechanisms including the reaction of hydroxyls with anhydrides such as, e.g., phthalic anhydride, maleic anhydride, succinic anhydride in typical molar ratios as disclosed in U.S. Pat. No. 6,432,864, the entire contents of which are incorporated herein by reference.

According to one embodiment of the present invention, the silicone (d) component is a silicone polymer of the general formula MDx D″y M*z having pendant groups that contains at least one organic acid designated as RCOOH.

In the general formula MDx D″y M*z:
M represents (CH₃)₃SiO_{1/2};
M* represents R(CH₃)₂SiO_{1/2};
D represents (CH₃)₂SiO_{2/2};
D″ represents (CH₃)(P)SiO_{2/2};
x is of from about 0 to about 100;
y is of from about 0 to about 40; and
z is from 0 to 2; in the above formulae for M* and D″,
R is alkyl, aryl, polyether, polyester, with at least one carboxylic acid (COOH) functionality.

According to one embodiment of the invention, x is 0 to about 80 and y is of from about 0 to about 25 and z is 0 to 2. In another embodiment of the invention, x is of from about 0 to about 60 and y is of from about 0 to about 20 and z is 0 to 2, and in yet another embodiment of the present invention, x is of from about 0 to about 25 and y is of from about 0 to about 10 and z is 0 to 2.

As stated above, length of silicone backbone can be altered to provide polyurethane foam properties. In one specific embodiment, x can be of from about 0 to about 30 and y+z can be of from about 0 to about 4. In another embodiment, x can be of from about 4 to about 8 and y+z can be of from about 0 to about 2. It will be understood by a person skilled in the art that these ranges include all subranges there between.

The quantity of silicone surfactant possessing carboxylic acid functionality (d) used in the present invention is typical for silicone surfactants. However, depending on the amount of amine catalysts used and amount of delay that may be required the concentration of the acid functionalized silicones can vary. It is also contemplated herein, that the acid functionalized silicone surfactants can be used in conjunction with unfunctionalized silicone surfactants to obtain the desired effect. The amount used could vary greatly depending on the needs of the cell stabilization and reactivity.

Surfactant blending to obtain the desired reactivity profile is known in the art, and in one embodiment of the invention, the acid functionalized silicone surfactant (d) ranges in amount from about 0.001 to about 10 weight percent of the total foam composition. In another embodiment of the invention, the silicone component (d) ranges in amount from about 0.005 to about 2 weight percent of the total foam composition.

According to an embodiment of the present invention, the blowing agent of the polyurethane foam-forming composition is water, which is employed to generate carbon dioxide in situ. Physical blowing agents such as, for example, blowing agents based on volatile hydrocarbons or halogenated hydrocarbons and other non-reacting gases can also be used in the polyurethane foam-forming composition. In another embodiment of the invention, the blowing agents can be used as auxiliary blowing agents, e.g., carbon dioxide and dichloromethane (methylene chloride). Other useful blowing agents for use in the polyurethane foam-forming composition include fluorocarbons, e.g., chlorofluorocarbon (CFC), dichlorodifluoromethane, and trichloromonofluoromethane (CFC-11) or non-fluorinated organic blowing agents, e.g., pentane and acetone.

The quantity of blowing agent varies according to the desired foam density and foam hardness as recognized by those skilled in the art. When used, the amount of hydrocarbon-type blowing agent varies from, e.g., a trace amount up to about 50 parts per hundred parts of polyol (phpp) and CO₂ varies from, e.g., about 1 to about 10%.

In another embodiment of the present invention, the polyurethane foam-forming composition can comprise optional components, such as, catalysts, crosslinkers, surfactants, fire retardant, stabilizer, coloring agent, filler, anti-bacterial agent, extender oil, anti-static agent, solvent and mixtures thereof.

According to one embodiment of the present invention, the optional components, which are known to those skilled in the art, include catalysts typically used to catalyze reaction of polyol with diisocyanate. It is common to use both an amine, metal salt, triazine and or a quaternary ammonium salt that produces isocyanurate moieties along with urethane linkages. Trimerization catalysts useful in the present invention can be selected from conventional polyisocyanate-trimerization catalysts. For example, the trimerization catalyst may be alkali salts of aliphatic, cycloaliphatic and aromatic carboxylic acids, for example, potassium acetate, potassium formate and potassium propionate, 2,4,6-tris(dimethylaminomethyl)phenol, N,N′,N″-tris(dimethylaminopropyl)hexahydrotriazine and diaza-bis-cycloalkene, and the like and mixtures thereof.

Suitable optional crosslinkers of the present invention include compounds having one or more leaving groups (i.e., groups that can be easily hydrolyzed), for example, alkoxy, acetoxy, acetamido, ketoxime, benzamido and aminoxy. Some of the useful crosslinkers of the present invention include alkylsilicate crosslinkers, tetra-N-propylsilicate (NPS), tetraethylorthosilicate, methytrimethoxysilane and similar alkyl substituted alkoxysilane compositions, methyltriacetoxysilane, dibutoxydiacetoxysilane, methylisopropoxydiacetoxysilane, methyloximinosilane and the like.

According to one embodiment of the present invention, the level of incorporation of the crosslinker ranges from about 0.01 weight percent to about 20 weight percent, in one embodiment, and from about 0.3 weight percent to about 5 weight percent and from about 0.5 weight percent to about 1.5 weight percent of the total composition in another embodiment.

Optional surfactants include polyethylene glycol, polypropylene glycol, ethoxylated castor oil, oleic acid ethoxylate, alkylphenol ethoxylates, copolymers of ethylene oxide (EO) and propylene oxide (PO) and copolymers of silicones and polyethers (silicone polyether copolymers), copolymers of silicones and copolymers of ethylene oxide and propylene oxide and mixtures thereof in an amount ranging from 0 weight percent to about 20 weight percent, more preferably from about 0.1 weight percent to about 5 weight percent, and most preferably from about 0.2 weight percent to about 1 weight percent of the total composition. The use of silicone polyether as a non-ionic surfactant is described in U.S. Pat. No. 5,744,703 the teachings of which are herewith and hereby specifically incorporated by reference.

Other additives may be added to polyurethane foam to impart specific properties to polyurethane foam, as known in the art, including, but not limited to, fire retardant, stabilizer, coloring agent, filler, anti-bacterial agent, extender oil, anti-static agent, solvent and combinations thereof.

In one embodiment the polyurethane foam-forming composition of the present invention has a density of from about 5 to about 100 kilograms per meter³. In another embodiment of the invention the polyurethane foam-forming composition has a density from about 20 to about 75 kilograms per meter³. In still another embodiment of the present invention the polyurethane foam-forming has a density from about 25 to about 45 kilograms per meter³.

Methods for producing polyurethane foam from the polyurethane foam-forming composition of the present invention are not particularly limited. Various methods commonly used in the art may be employed. For example, various methods described in “Polyurethane Resin Handbook,” by Keiji Iwata, Nikkan Kogyo Shinbun, Ltd., 1987 may be used. For example, the composition of the present invention can be prepared by combining the polyols, amine catalyst, surfactants, and additional compounds including optional ingredients into a premix. This polyol blend is added to the isocyanate. Finally an acceptable blowing agent is introduced to the mixture to aid in forming the cell structure of the foam.

According to one specific embodiment of the present invention, a process of preparing polyurethane foam, which comprises the steps of: (1) preparing at least one mixture of polyurethane foam-forming composition comprising: (a) at least one polyol; (b) at least one polyisocyanate; (c) at least one amine catalyst for the polyurethane foam-forming reaction; (d) at least one silicone having carboxylic acid functionality, and (e) at least one blowing agent. In another embodiment of the present invention a polyurethane foam is prepared by the process as described herein.

Temperatures useful for the production of polyurethanes vary depending on the type of foam and specific process used for production as well understood by those skilled in the art. Flexible slabstock foams are usually produced by mixing the reactants generally at an ambient temperature of between about 20° C. and 40° C. The conveyor on which the foam rises and cures is essentially at ambient temperature, which temperature can vary significantly depending on the geographical area where the foam is made and the time of year. Flexible molded foams usually are produced by mixing the reactants at temperatures between about 20° C. and 30° C., and more often between about 20° C. and 25° C. The mixed starting materials are fed into a mold typically by pouring. The mold preferably is heated to a temperature between about 20° C. and 70° C., and more often between about 40° C. and 65° C. Sprayed rigid foam starting materials are mixed and sprayed at ambient temperature. Molded rigid foam staring materials are mixed at a temperature in the range of 20° C. to 35° C. According to one embodiment of the invention, the process used for the production of flexible slabstock foams, molded foams, and rigid foams is the “one-shot” process where the starting materials are mixed and reacted in one step.

In additional to the polyurethane foams already described herein, the silicone surfactants of the present invention can also be used in viscoelastic polyurethane foam. Viscoelastic polyurethane foam, also known as “dead” foam, “slow recovery” foam, or “high damping” foam, is characterized by slow, gradual recovery from compression. While most of the physical properties of viscoelastic polyurethane foams resemble those of conventional foams, the density gradient of viscoelastic polyurethane foam is much poorer. Suitable applications for viscoelastic polyurethane foam take advantage of its shape conforming, energy attenuating, and sound damping characteristics. Specific applications determine the desired density of the viscoelastic polyurethane foam.

Polyol used in viscoelastic polyurethane foam is characterized by high hydroxyl number (OH) and tends to produce shorter chain polyurethane blocks with a glass transition temperature of resulting foam closer to room temperature.

Methods of making viscoelastic polyurethane foam can be in accordance with any processing techniques known to the art, such as, in particular, the “one shot” technique. Viscoelastic polyurethane foam produced by viscoelastic polyurethane foam-forming composition can have various physical parameters dependant on specific components used. A person skilled in the art can vary specific components based upon desired properties of viscoelastic polyurethane foam and intended use of viscoelastic polyurethane foam.

### EXAMPLES

As used in these examples, the following designations, terms, and abbreviations shall have the following meanings:
Hyperlite® E-848 is a 5,000-molecular-weight polyoxyalkylene polyol with a Hydroxyl Number of 30.0-33.0 mg KOH/g available from the Bayer Corporation.
Hyperlite® E-850 is a polymer polyol with a Hydroxyl Number of 18.2-22.2 mg KOH/g available from the Bayer Corporation.
DEOA-LF: Diethanolamine (2-(2-hydroxyethylamino)ethanol); crosslinker; available from The Dow Chemical Company.
Niax A-1: blowing amine catalyst; 70% weight bis(2,2′-dimethylaminoethyl ether) in 30% dipropylene glycol; available from General Electric Advanced Materials.
Niax® C-5: amine catalyst Pentamethyl diethylene Triamine, (N-[2-(Dimethylamino)ethyl]N,N′,N′-trimethyl-1,2-ethanediamine) available from General Electric Advanced Materials.
Niax® A-33: gelling amine catalyst; 33% weight triethylenediamine in 67% dipropylene glycol; available from General Electric Advanced Materials.
Niax® C-41: trimerization catalyst; 1,3,5-tris-(dimethylaminopropyl) available from the General Electric Advanced Materials.
TDI=Toluene diisocyanate (T-80)
Voranol® 490: polyether polyol; MW 490; OH number (mg/KOH/g) 490; available from The Dow Chemical Company.
Voranol® 800: Polyol; MW 278; OH number (mg/KOH/g) 800; available from The Dow Chemical Company.
Papi® 27 MDI: polymethylene polyphenylisocyanate isocyanate equivalent 134.0; NCO content 31.4; available from The Dow Chemical Company.
Index=“Isocyanate Index” means the actual amount of polyisocyanate used divided by the theoretically required stoichiometric amount of polyisocyanate required to react with all the active hydrogen in the reaction mixture multiplied by one hundred (100).

### Comparative Example 1: Examples 1 and 2

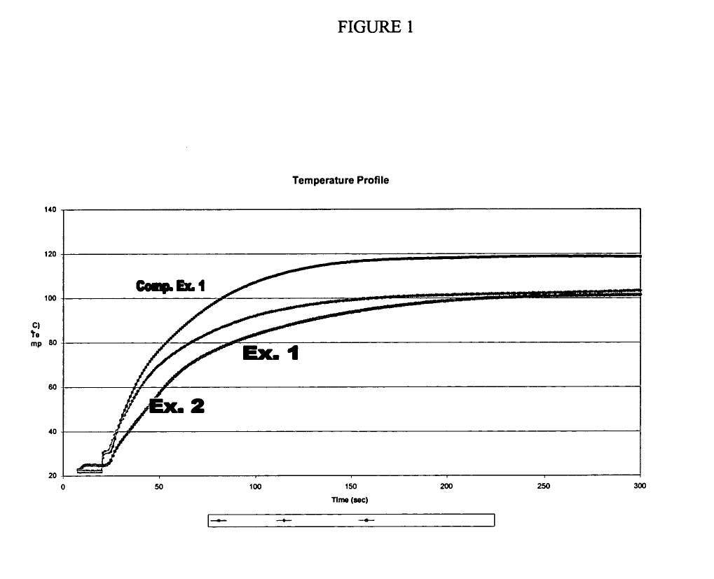

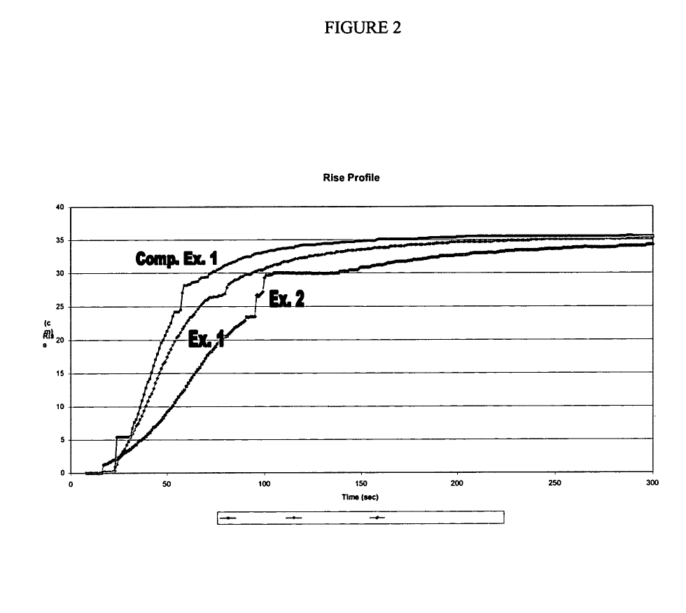

A typical high resilience (HR) flexible foam formulation (as displayed in Table 1) was used to prepare the polyurethane foams of Comparative Example 1 and Examples 1 and 2, by known and conventional means. Acid functional silicones surfactants (i.e., Examples 1 and 2) of the general formula M′D_{y}M′ were hydrosilated with organic acids and hydroxyl containing pendant groups and compared in free rise and urethane systems. Rise and temperature profiles of Comparative Example 1 and Examples 1 and 2 were measured and the results are displayed in FIGS. 1 and 2. The rise and temperature profiles show that organic acid pendant silicones surfactants significantly delayed the reactivity of the rising foams at equal use levels. This delay is shown in the retardation of the temperature and height of the foam.

TABLE 1

| | Comparative | | |
|---|---|---|---|
| Formulation | Example 1 | Example 1 | Example 2 |
| Hyperlite ® E-848 | 90 pphp | 90 pphp | 90 pphp |
| Hyperlite ® E-850 | 10 pphp | 10 pphp | 10 pphp |
| Water | 3.75 pphp | 3.75 pphp | 3.75 pphp |
| DEOA-LF | 1.65 pphp | 1.65 pphp | 1.65 pphp |
| Niax ® A-1 | 0.2 pphp | 0.2 pphp | 0.2 pphp |
| Niax ® A-33 | 0.33 pphp | 0.33 pphp | 0.33 pphp |
| n-Propanol, 3,3′- | 1.5 pphp | | |
| (1,1,3,3,5,5,7,7,9,9,11,11- | | | |
| dodecamethyl-1,11- | | | |
| hexasiloxanediyl)bis- | | | |
| (Surfactant Allyl | | | |
| Alcohol) | | | |
| Undecanoic Acid, 3,3′- | | 1.5 pphp | |
| (1,1,3,3,5,5,7,7,9,9,11,11- | | | |
| dodecamethyl-1,11- | | | |
| hexasiloxanediyl)bis- | | | |
| (Surfactant Undecylenic | | | |
| Acid)) | | | |
| 2-Butenedioic acid, | | | 1.5 pphp |
| monopropyl ester, 3,3′- | | | |
| (1,1,3,3,5,5,7,7,9,9,11,11- | | | |
| dodecamethyl-1,11- | | | |
| hexasiloxanediyl)bis- | | | |
| (Surfactant Allyl Alcohol + Maleic | | | |
| Anhydride) | | | |
| TDI | 49.13 | 49.13 | 49.13 |
| Index | 105 | 105 | 105 |

### Comparative Example 2, Examples 3-5

Exit time tests were performed with Comparative Example 2 and Examples 3-5. Comparative Example 2 and Examples 3-5 were prepared using the HR polyurethane foam formulation presented in Table 1 and the silicone surfactants displayed in Table 2, respectively. The HR polyurethane foams were prepared by known and conventional means.

Exit test time data was measured using a typical isothermal test at 160° F. and mold measuring 15″×15″×4″ as the foam exited the isothermal mold. The exit time from vents on the top of the mold indicate that Examples 3-5, prepared with alkyl acid pendant surfactants, retard the reactivity of the polyurethane foam, significantly. The Exit Time results as measured in seconds are presented in Table 2.

TABLE 2

| | Exit Time |
|---|---|
| Silicone Surfactant Pendant Group | (sec) |
| Comparative Example 2: Pentane, 2-methyl, 3,3′- | 43 |
| (1,1,3,3,5,5,7,7,9,9,11,11-dodecamethyl-1,11- | |
| hexasiloxanediyl)bis-(Surfactant) | |
| Example 3: Pentanoic, 3,3′- | 89 |
| (1,1,3,3,5,5,7,7,9,9,11,11-dodecamethyl-1,11- | |
| hexasiloxanediyl)bis-(Surfactant) | |
| Example 4: Undecanoic Acid, 3,3′- | 65 |
| (1,1,3,3,5,5,7,7,9,9,11,11-dodecamethyl-1,11- | |
| hexasiloxanediyl)bis-(Surfactant) | |
| Example 5: Maleic Acid, 3,3′- | 62 |
| (1,1,3,3,5,5,7,7,9,9,11,11-dodecamethyl-1,11- | |
| hexasiloxanediyl)bis-(Surfactant) | |

### Comparative Example 3: Example 6

The control of reactivity is also a desirable effect in the processing of rigid urethane foams for insulation. The delay of the reactivity can improve flow in intricate parts. Typical blowing agents include water, hydrochlorofluorcarbons, fluorocarbons, methyl formate and various blends of hydrocarbons. A conventional rigid foam formulation, as displayed in Table 3, was used to prepare Comparative Example 3 and Example 6.

Comparative Example 3 contained surfactant R1 which has a hydroxyl functional polyether pendant on a silicone backbone of the general structure of MDₓD′_{y}M and was prepared as follows: In a round 500 ml 4 neck round bottom flask the following component were charged: 187.64 g of (CH₂)₂—CH₃—O—(C₂H₄O)_{12—(C}₃H₆O)—OH, 112.54 g of silanic fluid MD₂₀D′₃M, and 0.06 g an amine buffer. The 4-neck flask was equipped with a thermocouple, and a nitrogen purge. Material was the agitated at approximately 250 rpm and heated to 85° C. Mixture was the catalyzed with 10 ppm of a 10% chloroplatinic acid solution in ethanol. Reaction took place with an exotherm of approximately 12° C. 15 minutes after addition of catalyst, the reaction vessel was sampled and found free of residual SiH using a basic solution testing for generation of hydrogen gas.

Example 6 was prepared with surfactant R2 which is identical to surfactant R1 except for the modification of the hydroxyl group by reacting with maleic anhydride at a 1:1 molar ratio to form carboxylic acid end groups. R2 was prepared as follows: 10 g of R1 from the procedure described above and 7.7 grams of Maleic anhydride and charging into a 500 ml round bottom flask equipped with a thermocouple, Nitrogen purge, and a Freidrich condenser. Materials were agitated and heated to 120° C. for 6 hours until there was no visible Maleic Anhydride left in the flask (solids). Material was cooled and collected in a bottle for testing.

TABLE 3

| | Comparative | |
|---|---|---|
| Formulation | Example 2 | Example 6 |
| Voranol ® 490 | 60 pphp | 60 pphp |
| Voranol ® 800 | 40 pphp | 40 pphp |
| Water | 3 pphp | 3 pphp |
| Niax ® C-41 | 0.3 pphp | 0.3 pphp |
| Niax ® C-5 | 0.5 pphp | 0.5 pphp |
| Cyclopentane | 15 pphp | 15 pphp |
| Surfactant R1 | 2 pphp | |
| Surfactant R2 | | 2 pphp |
| Total B Side | 120.8 | 120.8 |
| Papi ® 27 MDI | 145.0 | 145.0 |
| Index | 120 | 120 |

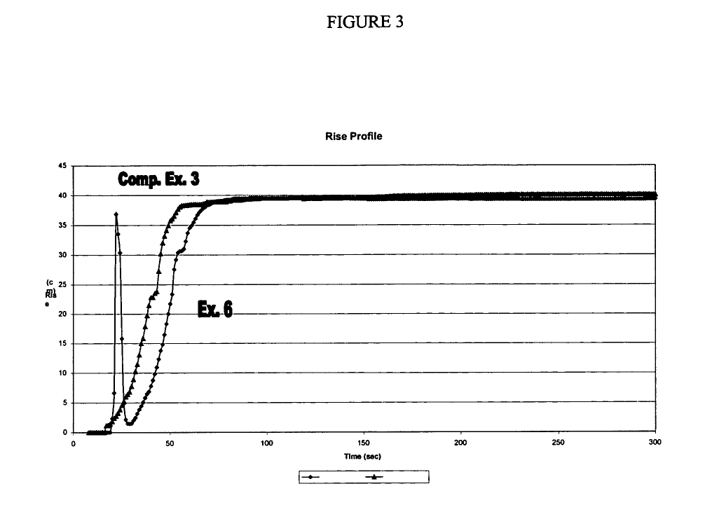

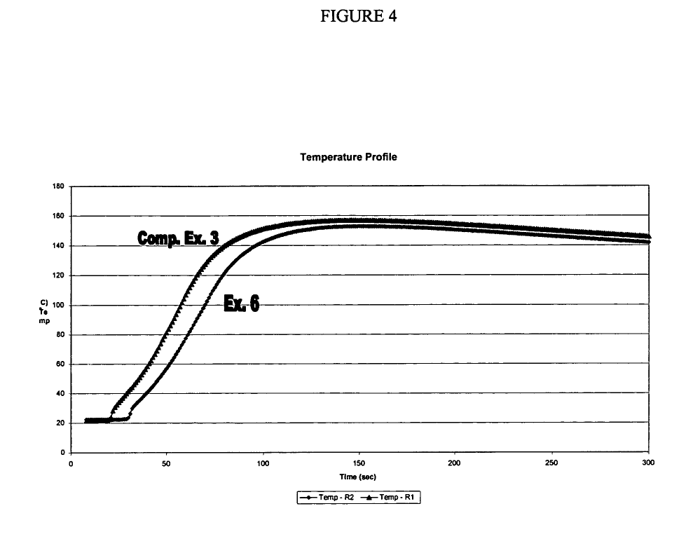

FIGS. 3 and 4 graphically illustrate the rise and temperature profiles of polyurethane foam Comparative Example 3 and Example 6. The rise height and temperature profiles as presented in FIGS. 3 and 4, respectively, were measured in a free rise. Polyurethane foam Example 6 displayed significant delay in rise and temperature as presented in FIGS. 3 and 4, respectively.

K factor samples were prepared from the free rise foam formulations of Comparative Example 3 and Example 6 to measure the resistance to thermal transfer of the foams. The experiments were preformed in triplicate and the average for each outcome is presented in Table 4. Example 6 (containing the acid terminated silicone surfactant) displayed improved flow, and thermal performance was not affected, see Table 4. The polyurethane foams of Comparative Example 3 and Example 6 displayed similar characteristics of appearance, however, the polyurethane foam of Example 6 exhibited delayed rise and temperature profiles.

TABLE 4

| | | String | Tack | End of | Density | |
|---|---|---|---|---|---|---|
| Surfactant | Cream | Gel | Free | Rise | (PCF) | K Factor |
| Comparative | 11 | 38 | 50 | 67 | 1.77 | 0.1463 |
| Example 3: | | | | | | |
| Surfactant R1 | | | | | | |
| Example 6: | 13 | 38 | 48 | 68 | 1.78 | 0.1468 |
| Surfactant R2 | | | | | | |

While the process of the invention has been described with reference to certain embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out the process of the invention but that the invention will include all embodiments falling within the scope of the appended claims.

What is claimed is:

1. A polyurethane foam-forming composition comprising:
(a) at least one polyol;
(b) at least one polyisocyanate;
(c) at least one amine catalyst for the polyurethane-forming reaction;
(d) at least one silicone possessing carboxylic acid functionality; and,
(e) at least one blowing agent.

2. The polyurethane foam-forming composition of claim 1 wherein the polyol is selected from the group consisting of polyether polyol, polyester polyol, polyetherester polyols, polyesterether polyols, polybutadiene polyols, acrylic component-added polyols, acrylic component-dispersed polyols, styrene-added polyols, styrene-dispersed polyols, vinyl-added polyols, vinyl-dispersed polyols, urea-dispersed polyols, polycarbonate polyols, polyoxypropylene polyether polyol, mixed poly(oxyethylene/oxypropylene)polyether polyol, polybutadienediols, polyoxyalkylene diols, polyoxyalkylene triols, polytetramethylene glycols, polycaprolactone diols and triols, aliphatic and aromatic polyester polyols, ester polyols, polyhydroxy polycarbonates, polyhydroxy polyacetals, polyhydroxy polyacrylates, polyhydroxy polyester amides, polyhydroxy polythioethers, polyolefin polyols, and mixtures thereof.

3. The polyurethane foam-forming composition of claim 1 wherein the polyol is of at least one polyol possessing an average molecular weight of from about 200 to about 10,000 and a hydroxyl number of from about 10 to about 4000.

4. The polyurethane foam-forming composition of claim 1 wherein the polyisocyanate (b) is selected from the group consisting of MDI, TDI and mixtures thereof.

5. The polyurethane foam-forming composition of claim 4 wherein the polyisocyanate is at least one selected from the group consisting of toluene diisocyanate, diphenylmethane isocyanate, methylene diphenyl diisocyanate, 2,4-toluene diisocyanate, 2,6-toluene diisocyanate, including polymeric versions thereof.

6. The polyurethane foam-forming composition of claim 1 wherein catalyst (c) is a mixture of amine catalyst and tin-containing catalyst.

7. The polyurethane foam-forming composition of claim 1 wherein silicone (d) possess the general formula:
MDx D″y M*z
wherein;
M represents (CH₃)₃SiO_{1/2};
M* represents R(CH₃)₂SiO_{1/2};
D represents (CH₃)₂SiO_{2/2};
D″ represents (CH₃)(R)SiO_{2/2};
x is of from about 0 to about 100;
y is of from about 0 to about 40; and
z is from 0 to 2; in the above formulae for M* and D″,
R is alkyl, aryl, polyether, polyester, with at least one carboxylic acid functionality

8. The polyurethane foam-forming composition of claim 7 wherein x is of from about 0 to about 80 and y is of from about 0 to about 25 and z is 0 to 2.

9. The polyurethane foam-forming composition of claim 7 wherein x is of from about 0 to about 60 and y is of from about 0 to about 20 and z is 0 to 2.

10. The polyurethane foam-forming composition of claim 7 wherein x is of from about 0 to about 25 and y is of from about 0 to about 10 and z is 0 to 2.

11. The polyurethane foam-forming composition of claim 1 wherein silicone (d) is at least one member selected from the group consisting of:
n-Propanol, 3,3′-(1,1,3,3,5,5,7,7,9,9,11,11-dodecamethyl-1,11-hexasiloxanediyl)bis-;
Dodecanoic Acid, 3,3′-(1,1,3,3,5,5,7,7,9,9,11,11-dodecamethyl-1,11-hexasiloxanediyl)bis-;
2-Butenedioic acid, monopropyl ester, 3,3′-(1,1,3,3,5,5,7,7,9,9,11,11-dodecamethyl-1,11-hexasiloxanediyl)bis-;
Pentane, 2-methyl, 3,3′-(1,1,3,3,5,5,7,7,9,9,11,11-dodecamethyl-1,11-hexasiloxanediyl)bis-;
Pentanoic, 3,3′-(1,1,3,3,5,5,7,7,9,9,11,11-dodecamethyl-1,11-hexasiloxanediyl)bis-;
Undecanoic Acid, 3,3′-(1,1,3,3,5,5,77,9,9,11,11-dodecamethyl-1,11-hexasiloxanediyl)bis; and,
Maleic Acid, 3,3′-(1,1,3,3,5,5,7,7,9,9,11,11-dodecamethyl-1,11-hexasiloxanediyl)bis-.

12. The polyurethane foam-forming composition of claim 1 wherein the polyol has a functionality of from about 2 to about 12.

13. The polyurethane foam-forming composition of claim 1 wherein the Isocyanate Index is of from about 60 to about 300.

14. The polyurethane foam-forming composition of claim 13 wherein the Isocyanate Index is of from about 80 to about 120.

15. The polyurethane foam-forming composition of claim 1 wherein the blowing agent is water.

16. The polyurethane foam-forming composition of claim 1 optionally comprises at least one component selected from the group consisting of catalysts, crosslinkers, other surfactants, fire retardant, stabilizer, coloring agent, filler, anti-bacterial agent, extender oil, anti-static agent, solvent and mixtures thereof.

17. The polyurethane foam-forming composition of claim 1 wherein the polyurethane foam has a density of from about 5 to about 100 kilograms per meter³.

18. The polyurethane foam-forming composition of claim 17 wherein the polyurethane foam has a density from about 20 to about 45 kilograms per meter³.

19. A process of manufacturing a polyurethane foam which comprises foaming the foam-forming composition of claim 1.

20. A polyurethane foam prepared by the process of claim 19.

21. The process of manufacturing a polyurethane foam which comprises foaming the foam-forming composition of claim 11.

22. A viscoelastic polyurethane foam prepared by the process of claim 19.
